(19) United States
(12) Patent Application Publication
(10) Pub. No.: US 2007/0265998 A1
(43) Pub. Date: Nov. 15, 2007

(54) Information Processing Device

(75) Inventors: Tatsuya Mori, Kyoto (JP); Takashi Esumi, Kyoto (JP); Muga Imamura, Kyoto (JP)

Correspondence Address: FISH & RICHARDSON P.C., P.O. BOX 1022, MINNEAPOLIS, MN, 55440-1022, US

(73) Assignee: ROHM CO., LTD., Kyoto (JP)

(21) Appl. No.: 11/746,917

(22) Filed: May 10, 2007

(30) Foreign Application Priority Data
May 15, 2006 (JP) 2006-134975

(51) Int. Cl. G06F 17/30

(52) U.S. Cl. 707/1

(57) ABSTRACT

An information processing device retrieves external data stored in an external memory and performs predetermined first processing for the external data thus retrieved. Here, the information processing device has: a storage that stores retrieval control information transmitted from outside; and a retrieval controller that controls retrieval of the external data according to the retrieval control information. This makes it possible to efficiently perform the retrieval of data from the external memory, and alleviate the burden on a control device corresponding to a BB-CPU.

This application is based on Japanese Patent Application No. 2006-134975 filed on May 15, 2006, the contents of which are hereby incorporated by reference.

### BACKGROUND OF THE INVENTION

1. Field of the Invention

The present invention relates to information processing devices that process information supplied from an external memory.

2. Description of Related Art

In recent years, there have been developed many electronic apparatuses, such as cellular telephones, that are so configured as to retrieve and process various content-related data and then output it, so that they can support multimedia. Some examples of such content-related data are music data in MIDI or MP3 format and image/video data in JPEG or MPEG format.

It is under this background that, in the cellular telephones, a baseband CPU (hereinafter referred to simply as a “BB-CPU”) that controls, for example, communication processing which telephones are essentially required to perform also performs such processing as retrieval of music data from an external memory (for example, a flash memory). An example of such communication terminals will be explained with reference to FIG. 3.

As shown in FIG. 3, a communication terminal 101 includes a communication processor 102, a BB-CPU 103, an IC chip 104, a flash memory I/F 107, and the like.

The communication processor 102 receives a signal from the BB-CPU 103, thereby performing transmission/reception of voice data of a caller, data modulation/demodulation, and the like. That is, the communication processor 102 performs various processing that should be performed by telephones.

The BB-CPU 103 controls, via the communication processor 102, various processing that should be performed by telephones, and also controls the IC chip 104 and the flash memory I/F 107. The configuration of the BB-CPU 103 itself is basically similar to that of a commonly used CPU.

The IC chip 104 has music data processing means that is composed of, for example, a register array 141, a FIFO (first-in first-out) memory 143, an audio decoder 144, and a DAC (digital-analog converter) 145. The flash memory I/F 107 performs music data input/output operations to the flash memory 108 based on the control of the BB-CPU 103.

In this communication terminal 101, music data stored in the flash memory 108 is played back as follows.

First, the BB-CPU 103 reads out a given amount of music data via the flash memory I/F 107, and then writes the music data thus read out into the FIFO memory 143 included in the IC chip 104. At the same time, the BB-CPU 103 writes information such as the type of music data and bitrate into the register array 141 for making it assist the execution of processing of music data.

The music data written into the FIFO memory 143 is read out by the audio decoder 144, where demodulation is performed thereto. Then, the resultant music data is converted into an analog signal by the DAC 145. Based on this analog signal thus obtained, music is played back. According to the progress of readout of music data from the FIFO memory 143, the BB-CPU 103 further reads out a given amount of music data from the flash memory 108 and then writes the music data thus read out into the FIFO memory 143.

With the processing described above, it is possible to play back music with almost no interruption based on the music data stored in the flash memory 108.

In the communication terminal described above, the BB-CPU 103 needs to constantly control readout or write of music data during playback of music. On the other hand, as mentioned earlier, since the BB-CPU 103 performs various processing such as communication processing and music playback processing, the BB-CPU 103 has to be relatively versatile in its processing method.

For example, in a case where readout or write of music data can be performed at a relatively low clock frequency while communication processing has to be performed at a high clock frequency, the BB-CPU 103 operates with reference to the high clock frequency. This makes the BB-CPU 103 inefficient in performing music playback processing, leading to high electric power consumption for the contents of processing.

In addition, if the BB-CPU 103 is made to perform too much processing concurrently, it may become overload and malfunction. Furthermore, to appropriately perform many processing concurrently, a BB-CPU that delivers performance high enough to do so is required. This may increase a manufacturing cost of a product provided with such a BB-CPU.

### SUMMARY OF THE INVENTION

In view of the problems described above, an object of the present invention is to provide information processing devices that can efficiently retrieve data from an external memory and that can alleviate the burden on a control device corresponding to the BB-CPU described above.

To achieve the above object, according to one aspect of the present invention, an information processing device retrieves external data stored in an external memory and performs predetermined first processing for the external data thus retrieved. Here, the information processing device is provided with: a storage that stores retrieval control information transmitted from outside; and a retrieval controller that controls retrieval of the external data according to the retrieval control information (a first configuration).

With this configuration, the retrieval of data from the external memory is mainly controlled by the retrieval controller provided in the information processing device. Thus, for example, by making the retrieval controller control only the data retrieval, it is possible to realize more efficient data retrieval as compared with the conventional configuration in which a BB-CPU is made to control the retrieval of external data.

Incidentally, for example, by making a control device corresponding to the conventional BB-CPU transmit retrieval control information, it is possible, while realizing retrieval of external data in a way in which the control of the control device is reflected to some extent, to alleviate the burden on the control device as much as possible. It is to be noted that, in the present specification, an “external memory” denotes any memory that is present outside of the information processing device. Examples of such a memory are a flash memory and the like, though not limited thereto. It is also to be noted that, in the present specification, “retrieval control information” denotes information used for controlling the retrieval of external data.

Preferably, in the first configuration described above, the retrieval controller may control only processing for reading out the external data and writing the external data thus read out into a predetermined memory provided in the information processing device according to the retrieval control information (a second configuration).

As described above, by making the retrieval controller control only retrieval of the external data (making the retrieval controller exclusively perform retrieval of the external data), it is possible to provide the retrieval controller with a configuration and design best suited for data retrieval. This makes it possible to perform retrieval of the external data more efficiently.

Preferably, in the first or second configuration described above, the retrieval control information may include information indicating a timing of start or stop of the data retrieval, and the retrieval controller may start or stop the data retrieval according to the retrieval control information (a third configuration).

With this configuration, it is possible to determine the timing of start or stop of the data retrieval, which is important in performing the retrieval of the external data, by the retrieval control information. This makes it possible to control such timing from outside, and accordingly expand the contents of the retrieval of the external data. Additionally, since the retrieval controller can obtain information on such timing from outside, it is possible to simplify the processing thereof.

Preferably, in one of the first to third configurations, the external data may be AD converted digital music information, and at least DA conversion may be performed as the first processing (a fourth configuration).

As a type of content information stored in the external memory such as a flash memory, AD converted digital music data is well known. In the information processing device configured as described above, such digital music data is obtained, and then DA conversion is performed thereto. This makes it possible to easily play back music via audio output means such as a loudspeaker.

Preferably, in one of the first to fourth configurations, the information processing device is an IC chip including: an input terminal to which the external data is inputted; an input terminal to which the retrieval control information is inputted; and an output terminal from which a result obtained by the predetermined first processing is outputted to the outside (a fifth configuration).

With this IC chip, by incorporating such an IC chip into electronic apparatuses, for example, it is possible to realize compact, lightweight electronic apparatuses while enjoying the benefits from one of the first to fourth configurations. This makes the invention more applicable to electronic apparatuses, such as portable terminals, which are strongly required to be compact and lightweight.

According to another aspect of the present invention, a communication terminal is provided with: a communication controller that controls at least communication processing; and the information processing device having one of the first to fifth configurations described above. Here, the communication controller transmits the retrieval control information to the information processing device (a sixth configuration).

With this configuration, it is possible to alleviate the burden on the communication controller as compared with a configuration in which the communication controller also controls the retrieval of the external data. Additionally, since the control of the communication controller can be reflected in the retrieval of the external data to some extent through transmission of the retrieval control information, it is possible to expand the contents of the retrieval of the external data. It is to be noted that, in the present specification, “communication processing” denotes processing for realizing communication, such as modulation/demodulation of communication data. It is also to be noted that, in the present specification, a “communication terminal” denotes an apparatus capable of communication, such as a cellular telephone, though not limited thereto.

### BRIEF DESCRIPTION OF THE DRAWINGS

This and other objects and features of this invention will become clear from the following description, taken in conjunction with the preferred embodiments with reference to the accompanied drawings in which:

FIG. 1 is a configuration diagram of a communication terminal of an embodiment of the invention.

FIG. 2 is a flow chart showing processing performed in the embodiment of the invention.

FIG. 3 is a configuration diagram of a conventional communication terminal.

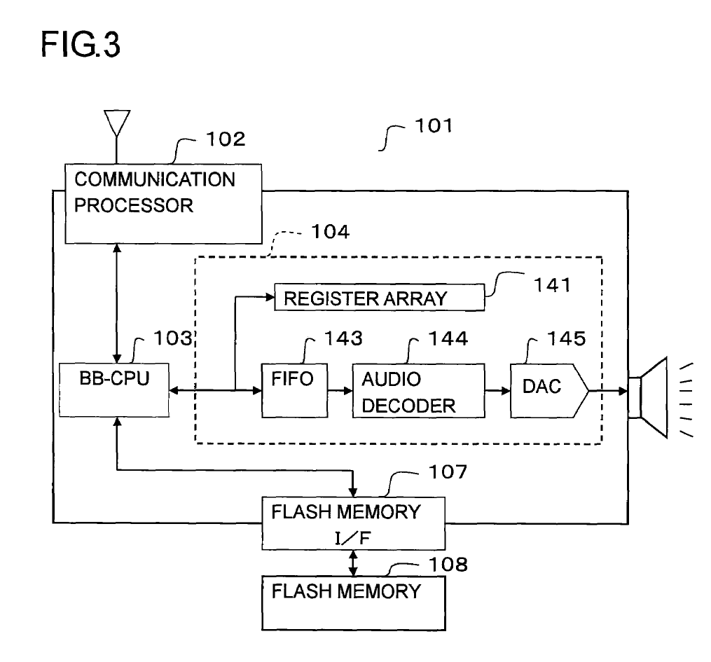

### DETAILED DESCRIPTION OF PREFERRED EMBODIMENTS

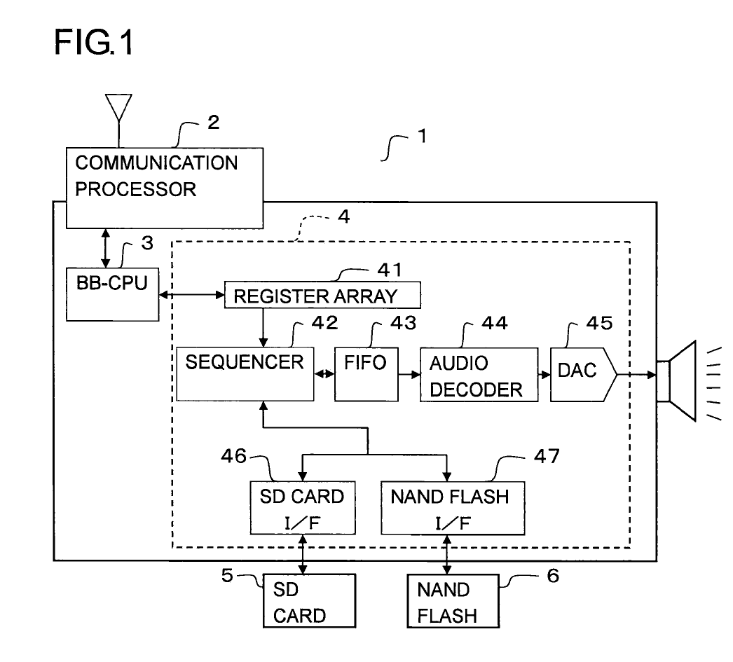

Hereinafter, an embodiment of the present invention will be described, taking up a communication terminal (for example, a cellular telephone) as an example. Now, descriptions will be given of the configuration of this communication terminal with reference to FIG. 1.

This communication terminal 1 includes a communication processor 2, a BB-CPU 3, an IC chip 4, and the like. Though not illustrated, the communication terminal 1 also includes, for example, an operation portion provided with push-button switches and the like, a display, and a power supply connector.

The communication processor 2 is provided with an antenna, a modulation circuit, a demodulation circuit, and the like. Under the control of the BB-CPU 3, the communication processor 2 performs various communication processing such as transmission/reception of voice data of a caller and data modulation/demodulation. This ensures a communication capability which telephones are required to offer.

The BB-CPU 3 performs communication processing via the communication processor 2 and other various processing. For music playback processing using an external memory, the BB-CPU 3 writes given information into a register array 41. Note that the configuration of the BB-CPU 3 itself is basically similar to that of a commonly used CPU.

The IC chip 4 includes, for example, a register array 41, a sequencer 42, a FIFO memory 43, an audio decoder 44, a DAC 45, an SD card I/F 46, and a NAND flash I/F 47.

The IC chip 4 also includes, as a terminal for external input/output operations, a terminal to which data (external data) stored in an SD card 5 and a NAND flash 6 (hereinafter collectively referred to as the “external memory”) is inputted, a terminal to which start information and stop information (retrieval control information), which will be described later, is inputted from the BB-CPU 3, and a terminal from which data obtained by performing audio decoding and DA conversion to the retrieved digital music data is outputted.

Information for music playback can be written into the register array 41 by the BB-CPU 3. Though not limited thereto, some specific examples of information for music playback are the format of music data, bitrate at which music is played back, the time at which music starts being played back, the time at which music playback is stopped (for example, at which a given time has elapsed after the start of playback), and the type of external memory (an SD card or a NAND flash memory) from which data is read out. It is to be noted that, in the present specification, the information described above is referred to simply as the “initial information”.

According to the information written into the register array 41, the sequencer 42 reads out music data from the external memory and then writes the music data thus read out into the FIFO memory 43 (specifically, the sequencer 42 performs the procedure from steps S21 to S26, which will be described later). Since the sequencer 42 is specialized in performing the processing described above, it has a configuration and design best suited therefor. This makes efficient retrieval of external data possible.

A given amount of music data can be written into the FIFO memory 43 by the sequencer 42, and the written music data is sequentially outputted to the audio decoder 44. This helps coordinate the timing of readout of music data with the timing of decoding and audio output, making it possible to play back music with no interruption.

After the music data outputted from the FIFO memory 43 is decoded by the audio decoder 44, it is converted into an analog signal by the DAC 45. Then, a loudspeaker produces an audio output according to the music data.

Since the SD card I/F 46 and the NAND flash I/F 47 are provided as an interface with the external memory, data (for example, AD converted digital music information) can be read out and written into the SD card 5 and the NAND flash 6 via the SD card I/F 46 and the NAND flash I/F 47 respectively.

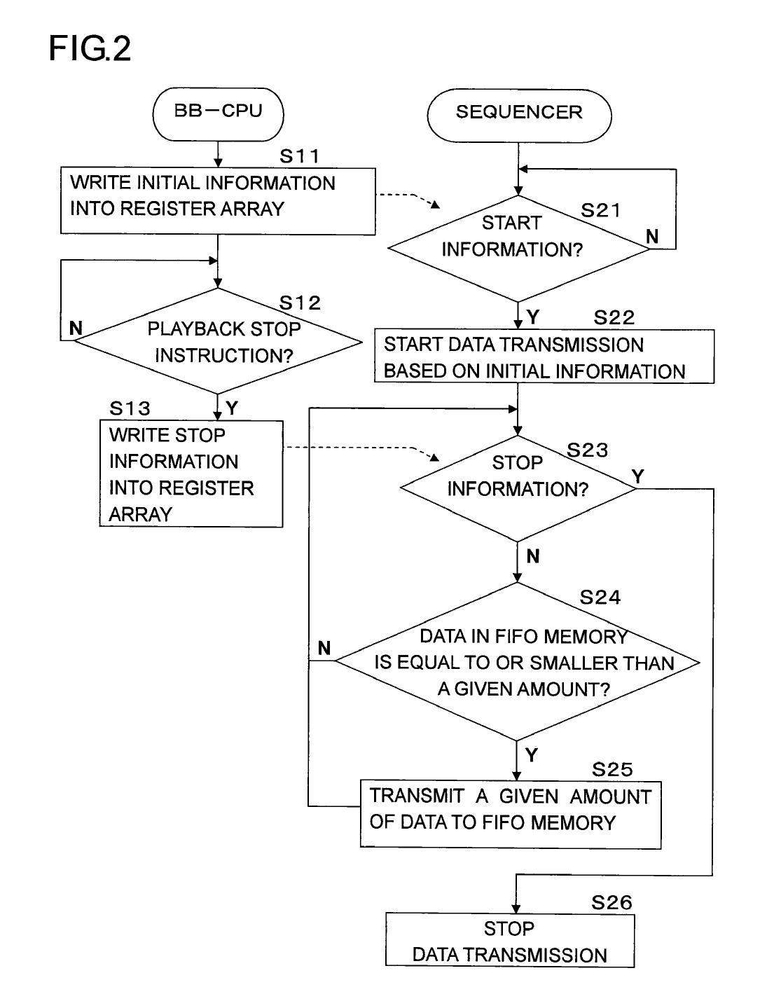

With the configuration described above, data transmission from the external memory to the FIFO memory in music playback processing is controlled by the sequencer 42. Here, the flow of the above-described data transmission will be described with reference to a flow chart shown in FIG. 2. It is to be noted that, in this embodiment, the time at which music playback is stopped is the time at which the user enters a stop instruction.

When the user enters a music playback instruction (for example, by operating a predetermined button), the BB-CPU 3 writes initial information into the register array 41 (step S1). As described earlier, the initial information includes information (start information) indicating the start of music playback.

In the meantime, the sequencer 42 monitors the information being written into the register array 41. When the start information is found to be written thereinto (Y in step S21), the sequencer 42 starts transmitting music data based on the contents of the initial information (step S22).

What is referred to here as the data transmission is data transmission from the external memory (5 or 6) to the FIFO memory 43. More specifically, the sequencer 42 monitors the amount of music data stored in the FIFO memory 43 (step S24), and, when the amount of music data stored in the FIFO memory 43 is found to be equal to or smaller than a predetermined threshold amount, the sequencer 42 further transmits a predetermined amount of music data to the FIFO memory 43 (step S25).

When the user enters a music playback stop instruction (for example, by operating a predetermined button), the BB-CPU 3 writes information (stop information) indicating stop of music playback into the register array 41 (step S13).

In the meantime, after the start of transmission of music data, the sequencer 42 checks whether or not stop information is written into the register array 41 (step S23). When stop information is found to be written thereinto, the sequencer 42 stops transmitting music data.

The procedure described above makes it possible to transmit music data from the external memory to the FIFO memory 43. For a role for the BB-CPU 3 in this procedure, the BB-CPU 3 simply has to write initial information into the register array 41 and write stop information into the register array 41 in response to a playback stop instruction.

As described above, the BB-CPU 3 is made to transmit start information and stop information (retrieval control information) to the register array 41. This makes it possible, while realizing retrieval of external data in a way in which the control of the BB-CPU 3 is reflected to some extent, to alleviate the burden on the BB-CPU 3 as much as possible.

Additionally, the retrieval of data from the external memory is mainly controlled by the sequencer (retrieval controller) 42 provided in an information processing device, and the sequencer 42 is specialized in controlling the data retrieval. This makes it possible to realize more efficient data retrieval as compared with the conventional technology by which the BB-CPU is made to perform overall control of the retrieval of external data.

The embodiment described above deals with a communication terminal. This, however, is not meant to limit the application of the invention in any way. The invention may be practiced in any other manner than specifically described above, with any modification or variation made within the spirit of the invention.

As described above, according to the information processing device of this embodiment, the retrieval of data from the external memory is mainly controlled by the sequencer (retrieval controller) 42 provided in the information processing device, and the sequencer 42 is specialized in controlling the data retrieval. This makes it possible to realize more efficient data retrieval as compared with the conventional configuration in which the BB-CPU is made to perform overall control of the retrieval of external data.

Furthermore, the BB-CPU 3 is made to transmit start information and stop information (retrieval control information) to the sequencer 42. This makes it possible, while realizing retrieval of external data in a way in which the control of the BB-CPU 3 is reflected to some extent, to alleviate the burden on the BB-CPU 3 as much as possible.

What is claimed is:

1. An information processing device for retrieving external data stored in an external memory and performing predetermined first processing for the external data thus retrieved, the information processing device comprising:
a storage that stores retrieval control information transmitted from outside; and
a retrieval controller that controls retrieval of the external data according to the retrieval control information.

2. The information processing device of claim 1, wherein
the retrieval controller controls only processing for reading out the external data and writing the external data thus read out into a predetermined memory provided in the information processing device according to the retrieval control information.

3. The information processing device of claim 1,
wherein the retrieval control information includes information indicating a timing of start or stop of the data retrieval,
wherein the retrieval controller starts or stops the data retrieval according to the retrieval control information.

4. The information processing device of claim 1,
wherein the external data is AD converted digital music information,
wherein at least DA conversion is performed as the first processing.

5. The information processing device of claim 1,
wherein the information processing device is an IC chip,
wherein the IC chip comprises:
an input terminal to which the external data is inputted;
an input terminal to which the retrieval control information is inputted; and
an output terminal from which a result obtained by the predetermined first processing is outputted to an outside.

6. A communication terminal comprising:
a communication controller that controls at least communication processing; and
the information processing device of claim 1,
wherein the communication controller transmits the retrieval control information to the information processing device.
